(19) United States
(12) Patent Application Publication
(10) Pub. No.: US 2016/0168893 A1
(43) Pub. Date: Jun. 16, 2016

(54) HINGE

(71) Applicant: Kason Industries, Inc., Newman, GA (US)

(72) Inventor: Burl M Finkelstein, Newnan, GA (US)

(73) Assignee: Kason Industries, Inc.

(21) Appl. No.: 14/566,318

(22) Filed: Dec. 10, 2014

(51) Int. Cl. E05D 7/10

(52) U.S. Cl. CPC E05D 7/1044

(57) ABSTRACT

There is disclosed a cam rise hinge (10) which includes a mounting flange assembly (12) pivotally coupled to a strap assembly (15). The mounting flange assembly includes a metal mounting plate (16) and a metal lower hinge flange (18). The lower hinge flange includes a cam recess (19) configured to receive cam (20) and cam follower (22). The lower hinge flange also includes a tension rod (25) having an upper end with a hex pin (38). The strap assembly includes a strap (41) extending from a cylinder portion (42). The cylinder portion includes a coupling end (45) with a vertically extending hexagonal channel (46) therethrough configured to receive snugly the hex pin of the tension rod. The cylinder portion also includes a threaded set screw passage (49) and set screw (51) oriented at the backside of the cylinder portion and extending to the hexagonal channel.

### TECHNICAL FIELD

This invention relates generally to door hinges, and more particularly to hinges used for commercial refrigerator and freezer doors.

BACKGROUND OF INVENTION

Walk-in cold rooms, such as walk-in coolers, freezers, or other refrigerated environments, are common in various industries, including supermarkets and grocery stores, commercial kitchens, and other food service facilities. The rooms typically have one or more access doors for entry and exit.

For the replacement, adjustment or cleaning of the hinge and door the NSF prefers that the hinge be a “lift-off” type to allow the door and the enclosure to be cleaned by lifting it off the hinges and hosing down the door assembly. A problem with these lift-off type doors is that the door may accidentally be lifted or raised due to encountering an object on the floor or riding up the back of a person's shoe while exiting the doorway. The door may be lifted to such a degree that a top portion of the hinge becomes disengaged from a bottom portion of the hinge, thereby allowing the door to become completely disengaged from the door jamb. This may cause harm to the door as well as harm to a person should the door fall upon them.

Another problem associated with these rooms is that refrigerator door is intended to be locked to prevent the theft of goods contained within the refrigerator. However, the door may be lifted to disengage the hinge portions from the door jamb, thereby allowing removal of the door and access to the refrigerator space.

Accordingly, there is a need in the art for a hinge that will allow for the door to be lifted off easily, which will not accidentally be disengaged, and which prevents tampering to allow unwanted removal of the door. It is to the provision of such therefore that the present invention is primarily directed.

### SUMMARY OF THE INVENTION

In a preferred form of the invention a hinge for pivotally coupling a door to a door jamb comprises a mounting flange assembly having a mounting plated adapted to be mounted to the door jamb and a flange extending outwardly from the mounting plate. The mounting plate has at least one mounting hole. The hinge also has a cam assembly coupled to the mounting flange which includes a tension rod, a cam coupled to the tension rod and a cam follower coupled to the tension rod and configured to mate with the cam. The hinge also has a strap assembly pivotally coupled to the mounting flange assembly through the cam assembly. The strap assembly includes a strap having at least one strap mounting hole and a coupling end having a tension rod channel therein configured to receive a portion of the tension rod. The coupling end has a front side facing away from the door and a rear side facing towards the door and the mounting plate when the door is in a door closed position. The coupling end has a set screw channel extending from the rear side to the tension rod channel and a set screw moveably mounted within the set screw channel for movement into locking engagement with the tension rod portion positioned within the coupling end. With this construction, when the door is in a closed position the set screw is inaccessible to prevent tampering, yet when the door is in an open position the set screw is accessible.

### BRIEF DESCRIPTION OF DRAWINGS

FIG. 1 is a perspective view of a cam rise hinge embodying principles of the invention in a preferred form.

FIG. 2 is a cross-sectional view of the cam rise hinge of FIG. 1.

FIG. 2A is a magnified view of a portion of the cross-sectional view of FIG. 2.

FIG. 3 is a top view of the cam rise hinge of FIG. 1, shown in a door closed position.

FIG. 4 is a top view of the cam rise hinge of FIG. 1, shown in a door opened position.

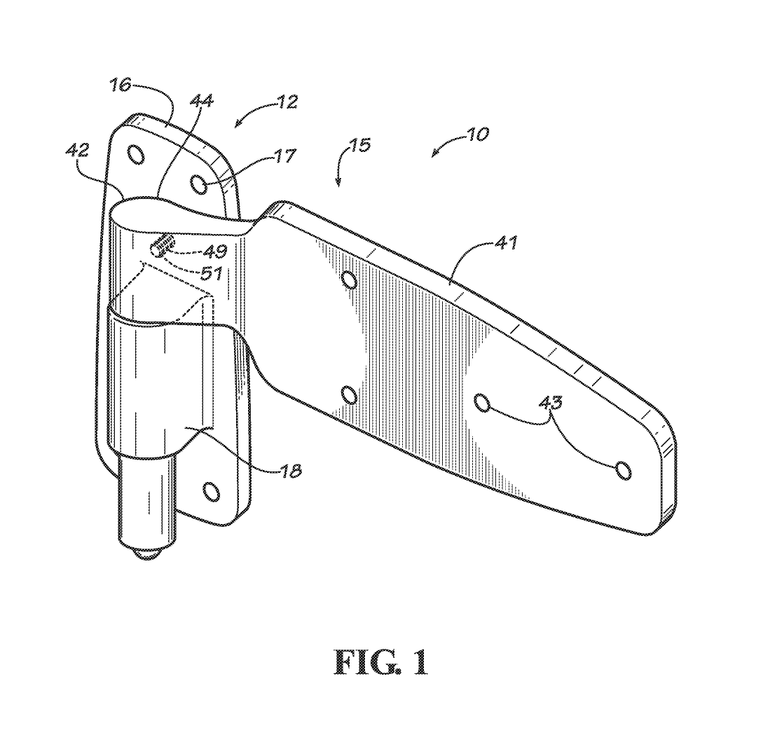

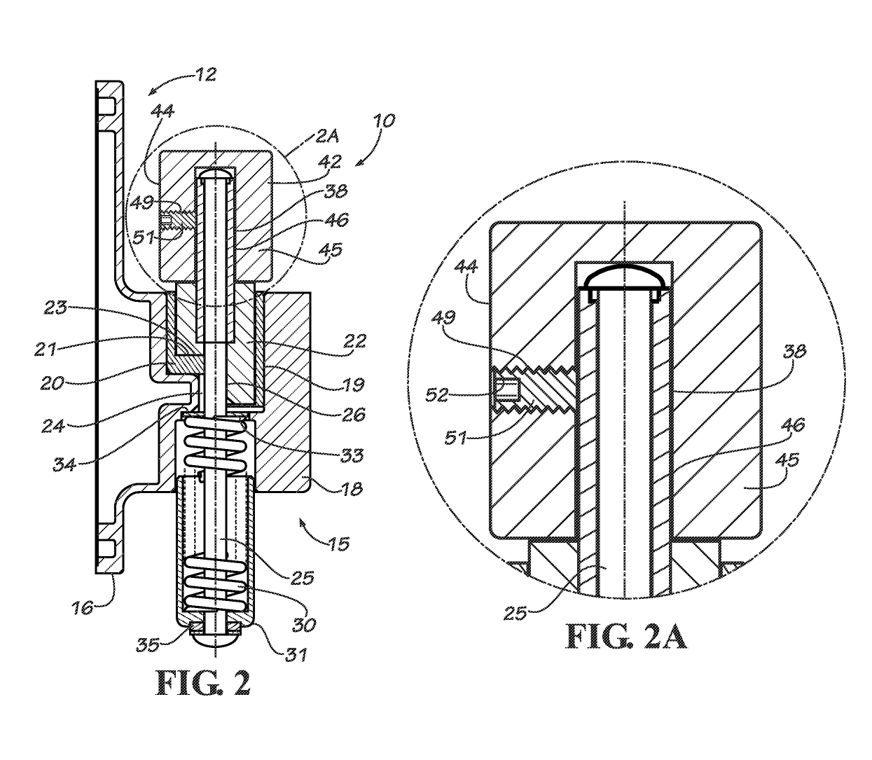

### DETAILED DESCRIPTION

With reference next to the drawings, there is shown a lift-off type cam rise hinge 10 according to the present invention. The hinge 10 includes a mounting flange assembly 12 pivotally coupled to a strap assembly 15. It is to be appreciated that the hinge 10 shown in the drawings is configured for use with a walk-in refrigerator or freezer door. The jamb J and door D are well-known in the art and need not be disclosed further herein. It is to be further appreciated that the hinge 10, either alone or in combination with another hinge in accordance with the present invention, supports a door (not shown) in the usual manner.

The mounting flange assembly 12 includes a metal mounting plate 16 having four mounting holes 17 therethrough adapted to receiving unshown mounting bolts or screws, and a metal hinge lower barrel or flange 18 extending from the mounting plate 16. As used throughout the entire disclosure herein, the terms screw and bolt are used interchangeably. The lower hinge flange 18 includes a cam recess 19 configured to receive a cam assembly which has an internally mounted cam 20 and cam follower 22 which enables the hinge to be a riser type hinge. The cam 20 includes a camming surface 21. The cam follower 22 has a cam following surface 23 configured to mesh or mate with the cam camming surface 21. The cam 20 and cam follower 22 are preferably made of a smooth, low-frictional plastic material such as nylon. The lower hinge flange 18 also includes a shoulder bolt hole 24 therethrough in which is mounted a tension bolt or rod 25. A rod channel or hole 26 passes through the center of the cam and cam follower 22 in which resides the tension rod 25 so that the cam follower 22 may rotate or pivot about the tension rod and relative to the underlying cam 20.

A compression spring 30 is coupled concentrically about the lower end of the tension rod 25. A cylindrical shell 31 is positioned over the spring 30 and telescopically mounted within a shell channel 32 for reciprocal movement therein in order to enclose the spring and conceal it from view. An internal washer 33 is positioned concentrically upon the tension rod and at the top end of the spring 30 and against a step 34 in the cam recess 19 so that the spring may bear against the washer 33. A pair of external washers 35 may also be mounted concentrically upon the tension rod externally of the shell 31. The actuation of opening the door and thereby moving the strap assembly 15 relative to the mounting flange assembly 12 rotates the cam follower upon the cam which thereby compresses the spring by raising the tension rod 25 and compressing the spring 30. The compressed spring biasing the door back to its closed position through the cam assembly. The telescopic mounting of the shell 31 within the shell channel 32 allows for vertical movement of the shell during spring compression. The upper end of the tension rod 25 is fitted with a non-round pin 38, shown and described hereinafter as a hexagonal shaped hex pin 38, which may be considered to be part of the tension rod 25.

The strap assembly 15 includes a metal elongated strap 41 extending from an upper barrel or cylinder portion 42. The elongated strap 41 has mounting holes 43 through which unshown screws pass to mount the strap 41 to a door D. The term cylinder portion 42 is meant to describe the enlarged casing located at the end of the strap which encases the tension rod, spring and cam assembly. The term cylinder portion is not intended to be limited to a cylinder shape, as this portion or parts of this portion may be of many known shapes which are not necessarily cylindrical in shape.

The cylinder portion 42 includes a coupling end 45 with a vertically extending hexagonal tension rod channel 46 therethrough configured to receive snugly the hex pin 38 of the tension rod 25. The tension rod channel 46 preferably terminates within the confines of the cylinder portion to enclose the channel at the top end. The cylinder portion 42 also includes a threaded set screw passage 49 oriented at the backside 44 of the cylinder portion and extends to the hexagonal channel 46. The backside 44 of the cylindrical portion is intended to mean the side facing the door or mounting plate 16 when the hinge and door is in a door closed position. The front side of the cylindrical portion is the side directly opposite the backside 44, i.e., the side facing away from the door when the hinge is in a door closed position. An externally threaded set screw 51 is threadably received within the set screw passage 49 and is adapted to move into locking abutment against the hex pin 38 positioned within the cylinder portion hex channel 46. Preferably, the set screw 51 is of substantially the same size as the set screw passage 49 so that the set screw head or drive portion 52 is recessed within the set screw passage 49 to prevent the unthreading of the screw through an exposed head.

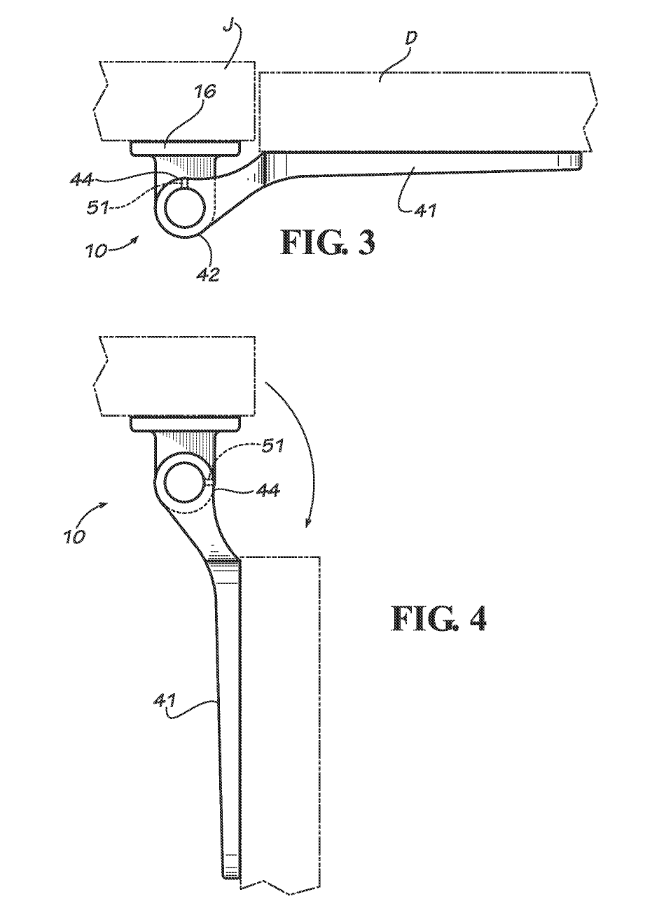

In use, the hinge 10 is mounted to the refrigerator or freezer door D in the conventional manner as is well known in the art. The mounting plate 16 is secured to the jamb J by the use of screws (not shown) that extend through the mounting plate mounting holes 17 and into the jamb J. A conventional walk-in refrigerator or freezer door D is similarly secured to the hinge 10 by four screws (not shown) that extend through the four mounting holes 43 of the strap 41. The set screw 51 is positioned to bear in locking engagement with the hex pin 38 to prevent the strap 41 from being lifted from the mounting flange assembly 12, and specifically from the hex pin 38. This locking of the strap to the hex pin prevents the door from being accidentally disengaged from the door jamb should the door encounter an object that vertically lifts the door. This locking through the set screw also prevents thieves or others from entering the cooler or cooled area by removing the door through a disassembling of the hinge components, i.e., lifting the strap 41 off the mounting flange assembly. The positioning of the set screw passage 49 and set screw 51 on the backside of the cylinder portion further enhances the unwanted disassembling of the hinge, for when the door is in a closed and locked position the set screw passage 49 and set screw 51 are positioned facing the jamb, as shown in FIG. 3, to prevent one from mating a tool with the screw head because of the tight fit or closeness between the cylinder portion 42 and the mounting plate 16, i.e., the screw head is inaccessible due to it facing the mounting plate and the limited space therebetween. However, when access is granted and the door is in an open position, as shown in FIG. 4, the cylinder portion 42 is rotated so that the set screw 51 is exposed and accessible, so that one may allowably unscrew and loosen the set screw to allow the lifting of the cylinder portion from the hex pin to remove the door for maintenance or cleaning purposes.

It should be understood that the hex pin 38 and corresponding channel 46 is not required to be hexagonal in shape and may be of any shaped which aids in preventing relative rotation between the cam follower and its corresponding channel, i.e., it may be oval, any polygonal shape, or any other non-round shape.

It should be understood that the terms cam and cam follower may be used interchangeably, as each simply includes a sloping surface configured to ride upon the other's sloping surface.

While this invention has been described in detail with particular reference to the preferred embodiments thereof and the best mode of practicing same, it will be understood that variations and modifications can be effected within the spirit and scope of the invention as described herein above and as set forth in the appended claims.

1. A hinge for pivotally coupling a door to a door jamb, the hinge comprising,
a mounting flange assembly having a mounting plated adapted to be mounted to the door jamb and a flange extending outwardly from said mounting plate, said mounting plate having at least one mounting hole,
a cam assembly coupled to said mounting flange, said cam assembly including a tension rod, a cam coupled to said tension rod and a cam follower coupled to said tension rod and configured to mate with said cam, and
a strap assembly pivotally coupled to said mounting flange assembly through said cam assembly, said strap assembly including a strap having at least one strap mounting hole and a coupling end having a tension rod channel therein configured to receive a portion of said tension rod, said coupling end having a front side facing away from said mounting plate and a rear side facing towards said mounting plate when the hinge is in a door closed position, said coupling end having a set screw channel extending from said rear side to said tension rod channel and a set screw moveably mounted within said set screw channel for movement into locking engagement with said tension rod portion positioned within said coupling end,
whereby when the door and hinge are in a closed position the set screw is inaccessible to prevent tampering, yet when the door and hinge are in an open position the set screw is accessible.

2. The hinge of claim 1 wherein the set screw has a head which is recessed within said set screw passage.

3. The hinge of claim 1 wherein said tension rod portion has a non-round configuration and wherein said tension rod channel has a non-round configuration corresponding to said tension rod portion non-round configuration to prevent relative rotational movement therebetween.

4. A hinge comprising,
a mounting plate,
a lower barrel mounted to said mounting plate, said lower barrel having a cam assembly recess therein,
a tension rod extending longitudinally within said lower barrel, said tension rod having an upper portion extending outwardly from said lower barrel,
a cam coupled to said tension rod and positioned at least partially within said cam assembly recess,
a cam follower coupled to said tension rod and positioned at least partially within said cam assembly recess,
a strap assembly having a strap and an upper barrel, said upper barrel having an exterior surface and a tension rod channel configured to receive said tension rod upper portion, said upper barrel having an internally threaded set screw passage extending from a position upon said exterior surface facing said mounting plate when said hinge is in a door closed position to a position within said tension rod channel, and
a set screw threadably received within said set screw channel and adapted to abut said tension rod upper portion within said upper barrel.

5. The hinge of claim 4 wherein the set screw has a head which is recessed within said set screw passage.

6. The hinge of claim 4 wherein said tension rod portion has a non-round configuration and wherein said tension rod channel has a non-round configuration corresponding to said tension rod portion non-round configuration to prevent relative rotational movement therebetween.

7. A hinge for pivotally coupling a door to a door jamb, the hinge comprising,
a mounting flange assembly having a mounting plate adapted to be mounted to the door jamb and a lower hinge flange extending outwardly from said mounting plate, said mounting plate having at least one mounting hole,
a cam assembly coupled to said lower hinge flange, said cam assembly including a tension rod, a cam journalled upon said tension rod and a cam follower journalled upon said tension rod and configured to mate with said cam, and
a strap assembly pivotally coupled to said lower hinge flange through said cam assembly, said strap assembly including a strap having at least one strap mounting hole and a coupling end having a tension rod channel extending from a bottom end of said coupling end and terminating within said coupling end, said tension rod channel receiving a top portion of said tension rod, said coupling end having a front portion facing away from the mounting plate and a rear portion facing towards said mounting plate when the hinge is in a door closed position, said coupling end having a set screw channel extending through said rear portion to said tension rod channel and a set screw moveably mounted within said set screw channel for movement into locking engagement with said tension rod top portion positioned within said coupling end,
whereby when the hinge is in a door closed position the set screw is inaccessible to prevent tampering, yet when the hinge is in an open position the set screw is accessible.

8. The hinge of claim 7 wherein the set screw has a head which is recessed within said set screw passage.

9. The hinge of claim 7 wherein said tension rod top portion has a non-round configuration and wherein said tension rod channel has a non-round configuration corresponding to said tension rod portion non-round configuration to prevent relative rotational movement therebetween.
